(19) United States
(12) Patent Application Publication
(10) Pub. No.: US 2002/0094787 A1
(43) Pub. Date: Jul. 18, 2002

(54) Method and apparatus for transmitting information from point-to-point

(76) Inventors: Mark S. Avnet, Lexington, NY (US); John Szinger, (US)

Correspondence Address: James D. Fornari, Esq., C/o Virgin Capital Corporation, 13th Floor, 645 Madison Avenue, New York, NY, 10022, US

(21) Appl. No.: 09/827,025

(22) Filed: Apr. 5, 2001

Related U.S. Application Data
(60) Provisional application No. 60/195,548, filed on Apr. 7, 2000.
(60) Provisional application No. 60/196,756, filed on Apr. 12, 2000.

(51) Int. Cl. H04B 1/00

(52) U.S. Cl. 455/68; 455/466; 455/566; 455/517

(57) ABSTRACT

The present invention is a method and apparatus for providing telecommunication connectivity between various electronic devices and to provide for digital data transfer from one device to other, peer-to-peer and/or point-to-point, either by way of a wireless device, over a switched-circuit analog audio network (i.e. Land based or cellular telephone service), or other wired networks. The invention provides an audio/visual experience in conjunction with the observation of static information from a display. Users of the system technology can interact with and receive information from a public display, advertisement, promotional display or other signage device to a personal hand held electronic device such as a PDA, cell phone or computer or other specialized receiving device for current use or later retrieval and usage. The audio/visual content information delivery system may be resident in billboards, kiosks, telephone booths, taxi tops or other advertising locations to provide embedded brochures, promotions and other marketing or promotional copy. The information delivery system can also be employed in conjunction with the delivery of non-commercial information such as data relating to displays of art. Users of the system technology can acquire information from a museum's database relating to art which they are observing, or that they want to learn about. The user can upload text, photos, audio and video clips and can communicate with others, either in real time or in archived memory about the exhibits that they are viewing. The system technology permits the receipt of data via a URL or similar designation, related to the display, which permits the user to download the data and use it to key to access a website or other form of electronic content or communication delivered over an electronic communication network. The system also permits variation of the delivered information in a context-sensitive manner by permitting the user to interact with the delivered information and determine what is of immediate interest, what they wish to store and retrieve at a later time, what they wish to transmit via e-mail to their inbox for home viewing and what they wish to ignore. The system transmitter is also capable of being varied to transmit different data, in accordance with the broadcast decisions of the advertiser, museum or site holder.

### RELATED APPLICATIONS

This is an application which is based upon and is part of a provisional application entitled Beam-to-Me, Ser. No. 60/195,548 filed Apr. 7, 2000, and a provisional application entitled Electronic Billboard Broadcast, Ser. No. 60/196,756 filed Apr. 12, 2000.

### BACKGROUND OF THE INVENTION

The present invention relates generally to telecommunication connectivity. More specifically, the present invention relates to an electronic device for transmitting information from a public area or display to a personal hand held device for providing additional data on a real time basis or for later retrieval and usage. The invention also permits interactivity and monitoring activity to a facility or later access to the monitored data by the displaying entity. The telecommunication connectivity includes, but is not limited to, advertisements, presentations, solicitations, purchasing suggestions, photos, video clips, audio text files, brochures, maps, coupons, and similar “contextually sensitive” content which is related to the underlying display.

It is known in the art that the more information a person absorbs from a particular display, the greater is the likelihood that he will remember the display and the advertisement or data that is being imparted. Information absorption is generally a function of its ability to catch the person's eye and then hold it for some period of time. In the context of the current web parlance, the term stickiness has often been used to describe the ability of a particular web site to hold the attention of the viewer, thus permitting the user to absorb information and conduct business or go further into the site itself. In a non-Internet context, the same principal of stickiness has always applied. The more an advertisement or display holds one's attention, the greater the likelihood that the advertisement will elicit a favorable action, such as the purchase of the product displayed.

Many different types of advertising and display decisions are predicated on a trade-off between catching the user's eye and not overwhelming the user or viewer with too much data. That trade-off is a difficult one because, inherent in catching a user's eye is that the display must convey enough information to satisfy the user's desire to know about the product. This can often conflict with the advertising or promotional display. One problem is that the display is static and once it is up, there is no way to augment the information without putting up a new display. One conventional method for augmenting the static display it to have a variable message which plays in conjunction with the display, such as a scrolling message display or a video clip that can play along with the static display. However, such augmentation is cumbersome, expensive and requires large display areas which are secure from tampering. Another problem is that the variable information is still displayer determined and the user has no input into the information that he or she is receiving.

In providing any type of static display, from art work in a museum to advertising on the street, it is desirable to have the viewer or user interact with the item displayed. It is desirable to have a cost effective system to permit display augmentation and information transmission to the user in such a manner as to permit the user to interact with the display and select the additional data that the user wishes to receive. There are many situations where the entity displaying the item, be it a product or a piece of art, would welcome viewer action such as purchasing the advertised product, make a contribution to the museum showing the work of art, respond to a survey regarding the display, answer a question or participate in a contest. There are also many situations where the companies or entities sponsoring the advertisement or promoting the exhibit would like to provide the viewer with further information if the viewer requests further information. An additional problem is that it is difficult to motivate a viewer to request information, to make a contribution or otherwise respond on a delayed basis. It is desirable to provide a ready and efficient method and apparatus to facilitate the exchange of information between viewers and those sponsoring the displays, be they promoters, advertisers, public interest entities, museums and the like.

### SUMMARY OF THE INVENTION

The invention, (hereafter referred to as Electronic Broadcast Billboard or EBB) is a method and apparatus to transmit information from a public advertisement, promotional display or other signage device or other public or private display (i.e., artwork) to a personal handheld electronic device such as a PDA, a cell phone or computer, or other specialized receiving device for either immediate or later retrieval and usage. It consists of transceiver mounted on or embedded or near in the display, signage or artwork. The transceiver can communicate wirelessly over a short distance, usually tens of meters. It may use infrared signals, or any of a number of digital RF-based technologies such as Bluetooth, Jini, WAP, etc.. The message transmitted by the EBB is typically a few seconds in duration. It either may repeat continually in a loop for any and all receiving devices, or transmit a single message to a user in response to a prompt.

In addition to the transceiver, the EBB device contains a small microprocessor and some amount of digital data storage, with the whole unit being powered by a battery, AC current, solar power unit, passive power transmission, or other powering scheme.

The unit is programmed to broadcast a small amount of data, usually a URL or similar token, related to the display in which it is embedded, designed so that the user who downloads this data can use it as a key to access a web site or other form of electronic content or communication delivered over an electronic communications network. The device that receives the data will typically have a small application running on it to interpret the message and store it for later use. The EBB unit may also be used to transmit larger amounts of information that may be the entire message, in addition to a URL or similar token.

The information transmitted by each EBB transceiver may be updated either via communication through its IR or other wireless I/O device, directly through a hardwired interface, or through a secondary wireless transceiver. This permits dynamic messaging to be controlled from a centralized location and ties the individual EBB transceivers into a network. The EBB Network components are comprised of a number of EBB transceivers, a connecting topology and a centralized EBB Control Station where the messages stored and transmitted by the individual EBB transceivers may be coordinated. The EBB Control Station permits scheduling of messages, coordinated messaging campaigns, day-parting and other similar broadcast and media scheduling schema.

EBB transceivers can work independently or in concert with the EBB Control Station. The Control Station is not required for the EBB transceivers to be fully functional.

The applications for the Electronic Billboard Broadcast go beyond simple advertising and marketing. This technology can provide useful information to recipients of the EBB messages by giving them additional information relative to the proximity of the EBB device. For example, the message can include the location of the nearest vendor where the product being advertised is sold, and can launch an application on the receiving device that displays a map to that vendor. The EBB can also provide time-sensitive information in cases where that is relevant; for example an advertisement for a movie that, in addition to only showing in certain neighborhood theaters, has a set of scheduled show times in the next few hours. The data transmitted by the EBB may also contain electronic coupons or other special promotional incentives for the recipient.

The EBB can record a log of the recipients of its message, and this log can be used as aid to the advertisement sponsors in tracking potential customers. Additionally, in versions where the EBB sends message in response to prompts, the EBB can make each message a unique code similar to a web cookie, enabling the sponsor to track individual's subsequent response to the message.

### EXAMPLE 1

### EBB in an Advertisement in a Train Station

An advertisement for E-Thingamajig.com, a web portal, is situated in a subway platform. Embedded in the advertisement is an EBB unit, transmitting data in a continuous loop over an IR modality. Subway riders waiting for the train to arrive can pull out their PDAs and receive the EBB's message, a small file that is a hyperlink to the E-Thingamajig web site. Later, the recipients of the message can click on the icon that represents the file, and the file will automatically launch a web browser and load the E-Thingamajig home page.

### EXAMPLE 2

### EBB in a Display outside a Movie Theatre

Outside a movie theatre box office is a series of posters advertising the films currently being shown inside. Each one contains an EBB transceiver. A passerby's curiosity is piqued by the poster for Eight Million Ways to Leave Your Lover, a new release which he has never heard of. This potential movie-goer pulls out his web-enabled PDA and receives a message from the EBB. Using this datum as a key, he can then browse the movie theatre's web site, starting at a custom-generated page that contains links to reviews of Eight Million Ways, a listing of show times for that evening, and whether the shows are sold out. He has the option to purchase his tickets electronically with his PDA, and if he so chooses, is provided with an e-coupon for a discount at the concession stand. Alternatively, the EBB may deliver text describing the movie, favorable reviews, even short video or audio clips directly to the PDA, which may be viewed directly on the PDA with no need to access the Internet.

### EXAMPLE 3

### EBB in a Supermarket Display

A supermarket promotional display stands at the end of aisle with an embedded EBB, promoting Joltolacola, a new kind of soft drink. Any shopper who receives a message from the EBB will receive an electronic coupon, redeemable at the checkout for a free container of Joltolacola. The redemption process is similar to that of receiving the e-coupon. The customer simply holds out his PDA and it beams the e-coupon to a receiving unit at the register.

### EXAMPLE 4

### Promotional Vehicle for Political Awareness

Jesse Santabarbara is running for public office. At a public appearance, his supporters distribute “Vote for Jesse Santabarbara” campaign buttons, each of which contains an EBB unit. Henceforth, as his supporters go about their daily routines wearing these buttons, anyone they meet can receive a message from the EBB. This message is a hyperlink to the official ElectJesseSantabarbara.org web site, where curious voters can go to learn more about Jesse, his message of governmental reform and his views on a variety of issues.

### EXAMPLE 5

### Hard Wire Information Transmission

Another way of moving data from the EBB transceiver to the end-user utilizes hardwired connectivity, and may do this in conjunction with connectivity over third-party networks such as phone lines. The “BeamToMe” implementation converts electronic data signals from a PDA, laptop computer or other similar device into an acoustic signal which can be transmitted and received over an ordinary phone connection. This type of implementation offers a level of freedom not associated with traditional data connections. It supports direct point-to-point data communication by two parties at any locations, so long as they are proximal to a telephone. It bypasses the Internet, the cumbersome and costly Internet Service Provider, and time-consuming dialup and logon procedures. The BeamToMe data transfer interoperates with a standard voice call. The device interfaces directly with the phone handset, providing an instant peer-to-peer digital data connection, allowing the user to transmit their in an ordinary voice conversation rather than go thru the trouble of establishing a separate data connection in a separate channel.

State-of-the-art electronics provide a high-bandwidth, low-noise signal even in a noisy ambient environment. In one execution, the device is similar in form to “walkman-type” stereo headphone: two little nubs and a y-shaped wire with a jack. The jack may plug directly into a PDA-type device, laptop or other device, or may terminate in a converter that receives signals transmitted using infrared from the device's IRDA port and converts them to audio signals. The two little nubs are the acoustic transducers. One goes on the phone by the speaker to listen, the other by the mouthpiece to transmit the signal. Signal optimization is enhanced using noise reduction technology that may include capturing the extraneous ambient sounds, inverting the phase and recombining them with the original signal to bring their amplitude closer to zero-level.

### DESCRIPTION OF THE DRAWINGS

FIG. 1 is a representational front view of a point-to-point information transmission system in accordance with the present invention.

FIG. 1A is a block diagram of the representation of the information broadcast device in accordance with the present invention.

FIG. 2 is a block diagram and flow chart of an open network architecture for a point-to-point information transmission system in accordance with the present invention.

FIGS. 3A through 3D are block diagrams and flow charts of a closed network architecture for a point-to-point information transmission system in accordance with the present invention.

### DETAILED DESCRIPTION OF A PREFERRED EMBODIMENT

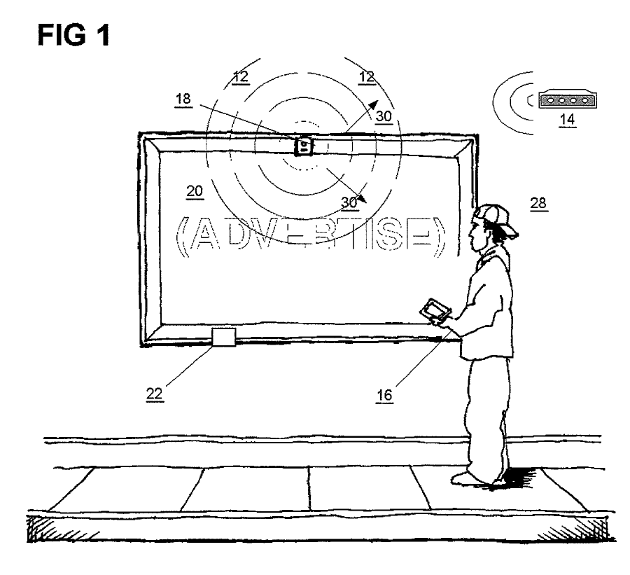

The present invention is described with reference to the enclosed Figures wherein the same numbers are utilized where applicable. Referring to FIG. 1, in a broadest embodiment, the present invention is directed to an information transmission system having an embedded information generating or broadcasting device 12, upstream data transmission capabilities 14 to upload the information to the broadcasting device 12 and a personal hand held electronic device 16, such as a PDA, cell phone, computer or other specialized receiving device which is capable of downloading the information from and otherwise interacting with the broadcasting device 12. The broadcasting device 12 may be comprised of a transceiver 18 mounted on or embedded in a display 20. The transceiver 18 may communicate wirelessly or there can be a hardwire connection 22 which permits the download of information more rapidly. The broadcasting device 12 also comprises a microprocessor 24 which is capable of receiving the data from the upstream transmission capabilities 14, processing it and responding to the data to provide the broadcast data. The broadcasting device 12, in a stand-alone context, will also comprise a digital data storage device 26 and a power source (not shown).

As is depicted in FIG. 1, a user 28 stops in front of the billboard 20 which contain the static advertisement and the embedded broadcast device 12. The embedded device is transmitting data 30 in a continuous loop over an infra-red (IR) modality. The user 28 can take out his or her receiving device 16 and receive the transmitted message, which can be a small file that is hyperlinked to the advertiser's web site or additional text and information that the user can view immediately or store. The user 28 can view the transmitted data, save as much or as little as her or she wants and can later launch a web browser using the downloaded file and load the advertiser's home page. At the same time that the user 28 is obtaining data from the broadcast device 12 in response to prompts by the user 28, it can code each prompted message in a unique manner to enable the sponsor to determine and track the user's 28 subsequent response to the message, i.e., did he or she go onto the home page, did they buy anything, what additional information did they request later, etc.

The system described above may operate with either an independent broadcast device 12 or in concert with a control station 14. The control station 14 is not required in order for the system to be operational and provide the requisite functionality, in accordance with the present invention. Where there is no control station which interacts with the broadcast device 12, the data being transmitted may be altered by local transmission of control signals to the transceiver. These may be manually controlled, or may be controlled by reference to time and day, controlled by reference to local environmental conditions, or changed in reference to certain interactions with the receiving unit. Data may be stored in the transceiver device itself in an internal database, and external control signals may determine which data will be transmitted. Alternatively, new data may be entered manually, by IR, wireless or other means, and this data may be directed to be transmitted by the transceiver.

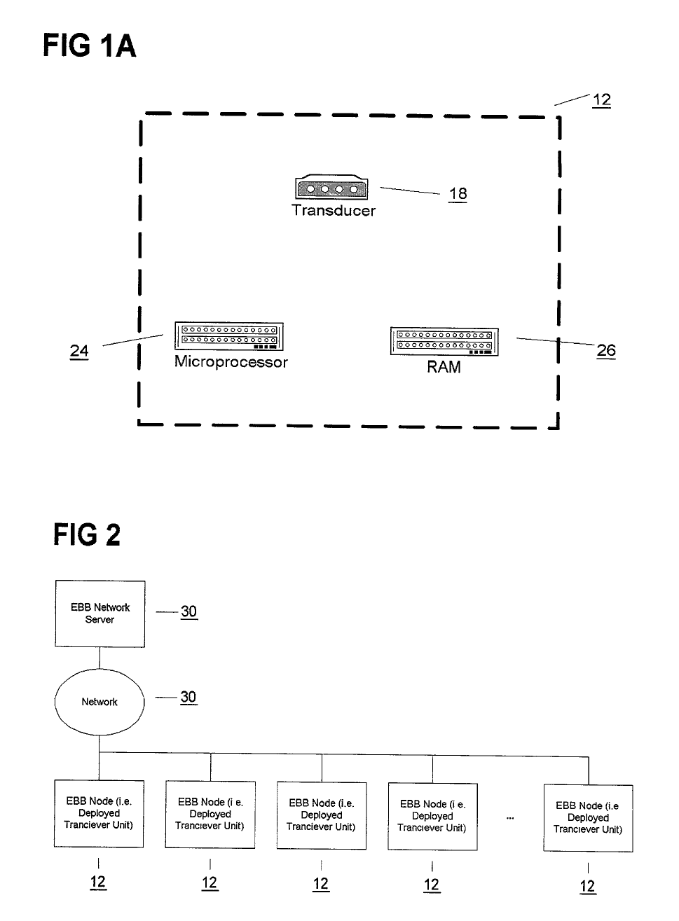

Referring to FIG. 2, there is shown an illustrative network architecture for the transmission of information in accordance with another aspect of the present invention. A network server 30 located at a central location transmits information to each of the transmission devices 12 either through network 32 which can be a hardwired interface or a secondary wireless transceiver which is a part of the transmission device 12. The network server 30 can transmit dynamic messaging to the transmission devices 12 which can be device specific or which can be a coordinated, uniform message. The network server 30 can have stored messages which it can transmit on a predetermined schedule, a random schedule, a feedback system based upon user 28 interaction, day parting and other similar broadcast and media scheduling schema. The network server 30 can also accumulate and process the responses from the users 28 and redefine the advertising or data parameters that it is transmitting. Business rules may be established which determine a series of responses to particular interaction parameters. Alternatively, an artificial intelligence engine may analyze the incoming data and cause a change in the messaging. Responses to these changes are collected and polled, and the messaging is automatically changed to optimize the response rate.

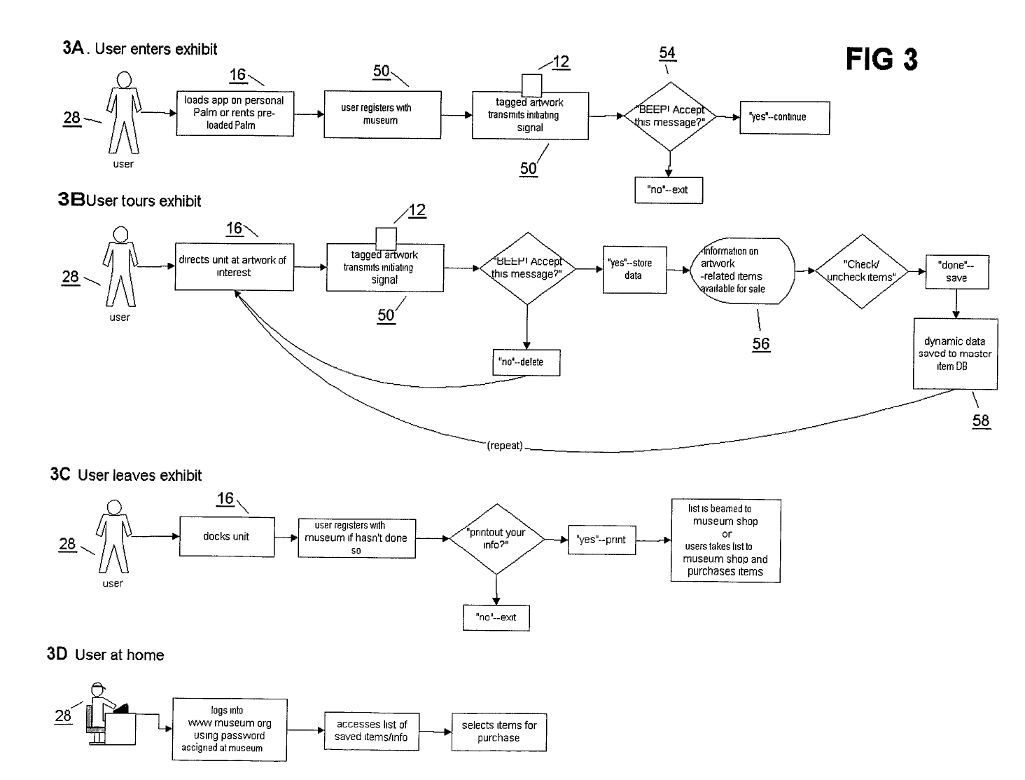

FIG. 3A is illustrative of an application which displays the operation of the present invention as part of a museum experience. The data transmission system provides a wireless (or wired) information delivery system that permits the museum visitor to interact with the exhibits, download information relating to exhibits, communicate with one another, either in real time or in archived commentary on the various exhibits, obtain maps of the museum, go to the museum store and get information about a product or a book on the particular exhibit, and link the museum with other pubic or private institutions or sponsors.

The museum goer (a class of user 28) enters the museum and loads the Museum application software on his or her personal Palm or rents a pre-loaded Palm. The user 28 then registers 50 with the Museum and is given a unique user code. The user then continues his or her tour of the Museum and when the user 28 desires information, he or she beams to the transceiver 12 situated in proximity to a piece of artwork 52. The transceiver 12 is transmitting an initiating signal 54 which the user 28 can either accept or reject. If the user 28 rejects the initiating signal 54, the application exits and no information is received. If the user 28 accepts the initiating signal 54, the transceiver may provide a loop of information, or may provide access to a server from which the user 28 can download information from a menu. By way of example, the user 28 in FIG. 3B has accepted the initiating signal 54 and has stored data 56 which he has selected from a menu. The user 28 has illustratively selected information on the artwork and related items available for sale. From the list of selected information, the user 28 can select items that he or she wishes to look at and possibly buy. Those selected items can then be stored and saved to a master item download 58.

The museum experience is further enhanced because the user 28 has the capability of transmitting his or her reactions to the artwork and having it stored for future viewers, much like a chat room on the Internet. This provides interactivity with both the art and with fellow museum goers.

The museum experience is temporally enhanced by the present invention. As is depicted in FIG. 3C, when the user 28 exits from the Museum, he or she can dock the personal electronic unit 16 and can either print out the information stored and can have it saved to the museum's file under his or her unique registration number. At the same time, the list of material that the user has saved on the master download can be beamed to the museum store so that the items can be available for the user when he gets there. As is shown in FIG. 3D, when the user 28 goes home, he or she can log onto the museum's web page and, using the unique registration number, access the information that he or she has stored in the museum's server. The user 28 can also access lists of the saved information and items and can select items for purchase.

The present invention has been described with reference to the above-detailed description. It is to be appreciated that other embodiments fulfill the spirit and scope of the present invention and that the true nature and scope of the present invention is to be determined with reference to the claims appended hereto. Using the foregoing embodiments, methods and processes, the transmission system personalizes the interactivity in real time. Variations and modifications exist, both as to the particular encoding used to generate the application and the media in which the experience exists. Those modifications and variations are within the scope of the invention.

We claim:

1. An interactive telecommunication system for interconnecting a viewer with an object being viewed comprising:
means for transmitting data relating to the object being viewed, said means being in close proximity to the object being viewed;
data storage means associated with the transmitting means; and,
means for receiving the data being transmitted by the data transmitting means.

2. The interactive telecommunications system of claim 1 wherein the means for transmitting the data transmits via a wireless communications protocol.

3. The interactive telecommunications system of claim 2 wherein the means for transmitting the data is embedded in the object being viewed.

4. The interactive telecommunications system of claim 1 further comprising:
means for receiving and recording the interaction between the viewer and the means for transmitting the data.

5. The interactive telecommunications system of claim 4 further comprising:
means for processing the interaction between the viewer and the means for transmitting the data.

6. The interactive telecommunications system of claim 5 further comprising:
means for transmitting the interaction between the viewer and the means for transmitting the data.

7. The interactive telecommunications system of claim 1 further comprising:
means for modifying the data being transmitted.

8. The interactive telecommunications system of claim 7 wherein the means for modifying the data being transmitted comprises a central control station distal from the transmitting means.

9. The interactive telecommunications system of claim 2 wherein the means for receiving the transmitted data is coupled to a hand held electronic device.

10. The interactive telecommunications system of claim 7 wherein the means for modifying the data being transmitted comprises a server and a machine readable medium that provides instructions which, when executed by the machine, cause the machine to:
load information related to the object; and
transmit the information related to the object to the receiving device.

11. A method for interactive telecommunication between a viewer and an object being viewed comprising:
presenting the object;
transmitting information related to the object to be received by a user device.

12. The method of claim 11 further comprising:
a pointer;
sending a request for information from the user device to a server pointed to by the pointer;
sending requested information to the user device from the server; and
receiving the requested information at the user device.

13. The method of claim 11 wherein the pointer comprises a Uniform Resource Locator.

14. The method of claim 11 further comprising:
varying the information sent to the user device from the server.

15. A machine readable medium that provides instructions which, when executed by a machine, cause the machine to:
load information related to an object; and
transmit, via a wireless communications medium, the information related to the object to a receiving device.

16. The machine readable medium of claim 15 providing further instructions which, when executed by the machine, cause the machine to receive a request for transmitting the information related to the object prior to transmitting the information related to the object.

17. The machine readable medium of claim 16 wherein the object comprises a display device.

18. A machine readable medium that provides instruction which, when executed by a machine, cause the machine to:
scan a wireless communication medium for a signal, the signal indicating availability of information related to an object; and
receive the information transmitted via the signal.

19. The machine readable medium of claim 18 providing further instructions which, when executed cause the machine to display the information on a user display.

20. The machine readable medium of claim 19, wherein the information is a first information, providing further instructions which, when executed cause the machine to:
after displaying the first information, prompt a user as to whether to request a second information;
send a request for the second information; and
receive the second information.

21. The machine readable medium of claim 18 wherein the object comprises a display device.

22. The machine readable medium of claim 18 providing further instructions which, when executed cause the machine to query a user as to whether to scan for the signal prior to scanning for the signal.
